(19) United States
(12) Patent Application Publication
(10) Pub. No.: US 2014/0196617 A1
(43) Pub. Date: Jul. 17, 2014

(54) Round Baler Debris Catcher

(71) Applicant: Ted Lacey, Trent, SD (US)

(72) Inventor: Ted Lacey, Trent, SD (US)

(21) Appl. No.: 14/151,518

(22) Filed: Jan. 9, 2014

Related U.S. Application Data
(60) Provisional application No. 61/750,667, filed on Jan. 9, 2013.

(51) Int. Cl. A01F 15/08

(52) U.S. Cl. CPC A01F 15/08
USPC 100/299

(57) ABSTRACT

A novel round baler debris catcher is provided. The round baler debris catcher comprises a pair of panels that are attached in a rigid, angled relation to each other and are adapted to span the gap between a round baler's pickup head and rear axle. The present round baler debris catcher is flexibly attached to the rear axle of the round baler such that it can accommodate the vertical movement of the round baler when the round baler is in use. By spanning the gap between the pickup head and the rear axle, the present invention prevents leaves and fines from falling therethrough and ensures that they will be incorporated into the bales generated by the round baler.

### CROSS REFERENCE TO RELATED APPLICATION

This application claims the benefit of U.S. Provisional Application No. 61/750,667 filed on Jan. 9, 2013 entitled “Round Baler Leaf Saver.” The above identified patent application is herein incorporated by reference in its entirety to provide continuity of disclosure.

### BACKGROUND OF THE INVENTION

1. Field of the Invention

The present invention relates to round balers. More specifically, the present invention relates to devices that are mounted below the pickup for catching leaves and fine debris to be added to the baled material.

Many models of commercially-available round balers have a gap between the pickup head and the rear axle of the device, which leaves and fines can potentially fall through. When leaves and fines fall through this gap, they are not incorporated into the bale, which is undesirable because leaves and fines make bales denser and also have vital nutrients for animals that feed on the baled material. Due to the loss of these leaves and fines, individuals generally purchase material to supplement their regular baled material, however this is an unnecessary expense that can be simply avoided if there was a device that spanned the gap between the rear axle and the pickup head of a round baler and collected the leaves and fines that would ordinarily fall therethrough.

Leaf or fine catching or reclamation devices for round balers are known in the prior art, however these systems generally incorporate at least one conveyor belt and are complicated. Such systems cannot be mounted to an already existing round baler without significant effort and technical knowledge. Therefore, there is a need for a simple device that can be easily installed onto an already existing round baler to prevent leaves and fines from falling through the gap between the pickup head and the rear axle.

The present round baler debris catcher spans the gap between the rear axle and the pickup head, preventing leaves and fines from falling therethrough and ensuring that they are incorporated into the bales generated by the round baler. The present invention is flexibly attached to the rear axle of the round baler so that the device can account for the vertical movement of the round baler while the round baler is in use. The present invention comprises two panels that are held in a fixed relation to each other and are disposed at an angle ideally suited to extend between the pickup head and the rear axle. When in use, leaves and fines collect on the present round baler debris catcher and pile up, as they pile up they are brought into the baler chamber as usual and incorporated into the bales.

2. Description of the Prior Art

Devices have been disclosed in the prior art that relate to attachments for balers that assist in picking up or retaining material to be baled. These include devices that have been patented and published in patent application publications. These devices generally relate to conveyor belt or pickup head attachment systems. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 6,601,375 to Grahl, which discloses an extra wide crop pickup and feeding system for devices such as balers. Grahl comprises a rotatable roller member extending across the crop inlet and a pair of rotatable augers on the outward sides of the crop inlet. The augers redirect material towards the center of the crop inlet, efficiently maximizing the amount of material that the device can pick up per pass. Grahl does not provide an additional mechanism for catching material that would otherwise fall through the pickup. The present invention is adapted to work with pickup systems such as Grahl and provides an additional means, positioned below the baler's pickup, for catching leaves and other fine debris so that they can be added to the baled material.

Another such device is U.S. Pat. No. 7,337,603 to Johnson, which discloses a leaf reclamation device for round balers. Johnson comprises a return feed conveyor belt positioned below the inlet to the bale chamber, which feeds the caught material into a trough, which then in turn transports the material into the bale chamber. Like the present invention, Johnson attaches beneath the inlet to the bale chamber, however the present invention comprises a series of hingedly attached panels, rather than a conveyor belt apparatus.

U.S. Pat. No. 7,654,069 to Dunham discloses a baler frame for mounting accessories, such as a wind guard or a rotor, thereto for assisting in the picking up of material. The present invention also assists in picking up the maximum amount of material from the ground to be baled, however the present round baler debris catcher ensures that material that is picked up by the baler stays within the baler chamber and does not fall through, rather than increasing the total amount of material that is initially picked up.

The present invention provides a novel means for ensuring that leaves and fines do not fall through the gap between the pickup head and the rear axle present in some models of round balers. The leaves and the fines are high nutrient components of the baled material, thus there is a substantial desire not to lose this material when baling. The present round baler debris catcher comprises a pair of panels attached in angled manner relative to each other that are adapted to span the gap present at the inlet to the baling chamber of a round baler. One of the plates is attached to the rear axle of the baler and the other end rests against the pickup head. The end resting against the pickup head is angled relative to the other plate to account for the movement of the flexible pickup head. Leaves and fines that would ordinarily fall through this gap are instead collected by the present invention, allowing them to be incorporated into the bales. It substantially diverges in design elements from the prior art and consequently it is clear that there is a need in the art for an improvement to existing debris catching devices for round balers. In this regard the instant invention substantially fulfills these needs.

### SUMMARY OF THE INVENTION

In view of the foregoing disadvantages inherent in the known types of leaf and fines catching means for round balers now present in the prior art, the present invention provides a new leaf and fine catching means for round balers wherein the same can be utilized for providing convenience for the user when baling material.

It is therefore an object of the present invention to provide a new and improved round baler debris catcher device that has all of the advantages of the prior art and none of the disadvantages.

It is another object of the present invention to provide a round baler debris catcher that can be readily installed on a wide range of round baler models.

Another object of the present invention is to provide a round baler debris catcher that prevents the loss of baled material and improves the nutrition of the bales.

Yet another object of the present invention is to provide a round baler debris catcher that accounts for the movement of the pickup head portion of the round baler.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2 shows a perspective view of the present invention mounted to a round baler with a call out showing the attachment means.

FIG. 3 shows a perspective view of the present invention mounted to a round baler and in use.

### DETAILED DESCRIPTION OF THE INVENTION

Reference is made herein to the attached drawings. Like reference numerals are used throughout the drawings to depict like or similar elements of the round baler leaf and fines catcher. For the purposes of presenting a brief and clear description of the present invention, the preferred embodiment will be discussed as used for attaching to a conventional round baler. The figures are intended for representative purposes only and should not be considered to be limiting in any respect.

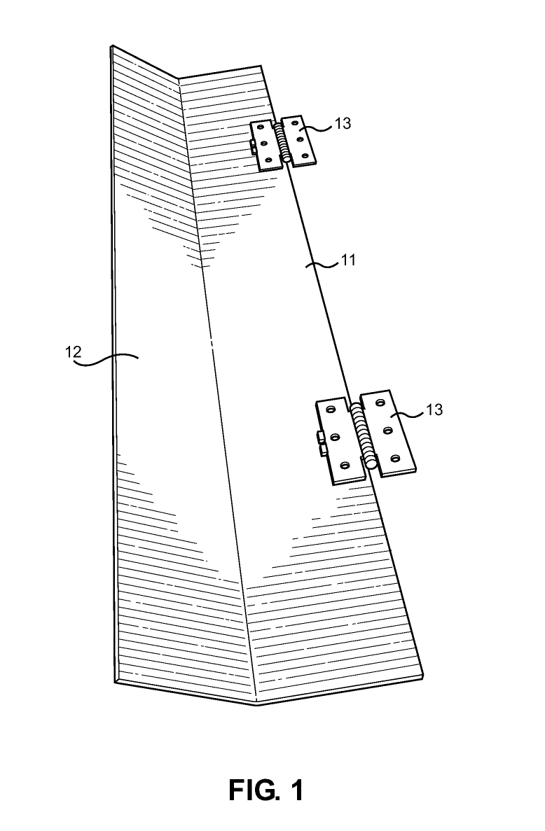

Referring now to FIG. 1, there is shown a perspective view of the present invention. The present invention is designed to be affixed to the rear axle of certain models of round balers and prevent leaves and fines from falling through the bale chamber. The present round baler debris catcher comprises a first panel 11 and a second panel 12 attached in an angled relation to each other. The panels 11, 12 of the present invention are composed of hard, inflexible material, such as hard plastic, wood, or metal. The first panel 11 has a first end and a second end. The second panel 12 is attached to the first end of the first panel 11. The second panel 12 is disposed at an obtuse angle when measured in relation to the first panel 11 so that the device is properly positioned such that it is capable of catching leaves and fines when affixed to a round baler.

In the preferred embodiment of the present invention, the joint between the panels 11, 12 is inflexible and holds the first and second panels 11, 12 in a rigid position in relation to each other. In alternative embodiments of the present invention, the connection between the panels 11, 12 may be hinged such that it is capable of adjusting position while the device is in use or may be adjusted by a user prior to use. The hinged attachment between the two panels 11, 12 allows the present invention to accommodate vertical movement of the round baler when in use. In this alternative embodiment, the present invention may have a locking mechanism preventing the second panel from dropping below a certain angle, preventing the fines and leaves resting on the panels 11, 12 from falling through the gap between the rear axle and the pickup head.

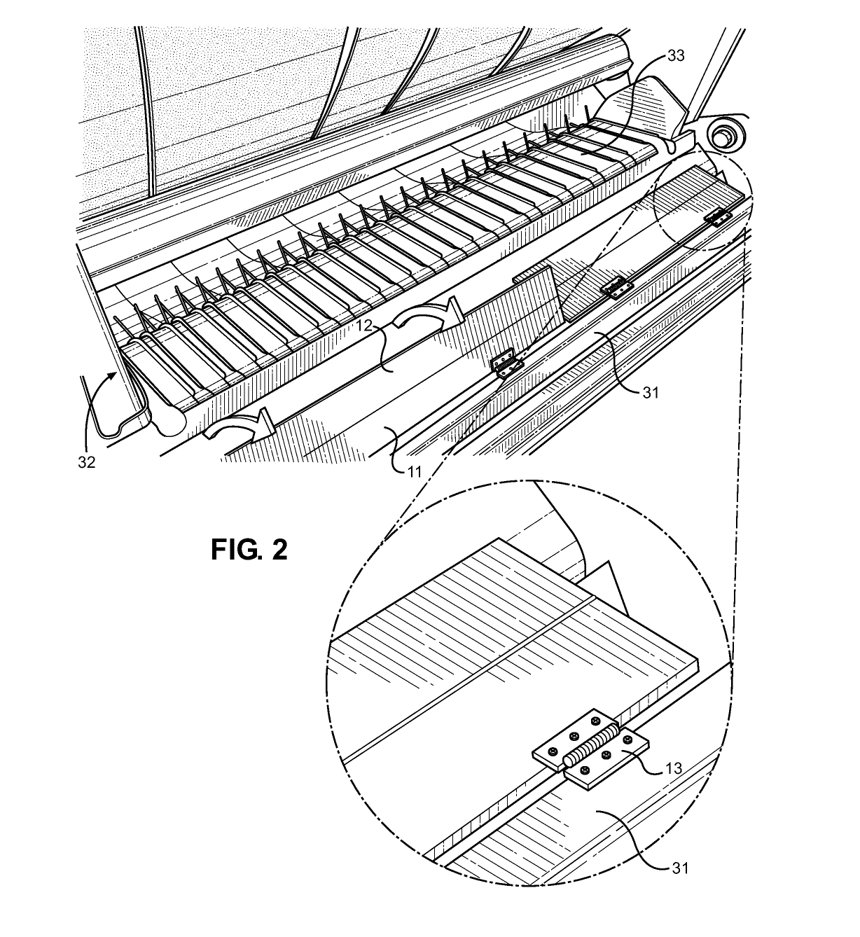

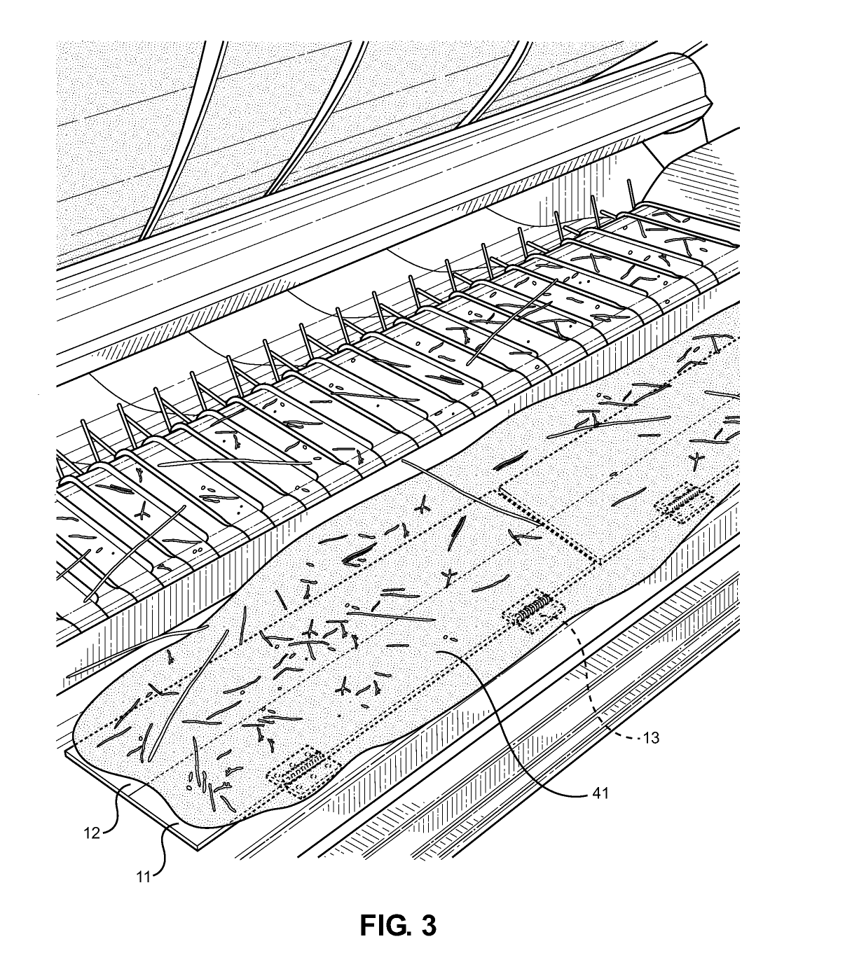

Referring now to FIGS. 2 and 3, there are shown perspective views of the present invention mounted to a round baler. The present invention is designed to be affixed to the rear axle 31 of a round baler 32 to span the gap between the rear axle 31 and the pickup head 33, preventing leaves and fines from falling therethrough. The present invention collects leaves and fines, ensuring that they do not fall therethrough, so that they are added to the bales created by the round baler to which the present invention is attached. The inclusion of the leaves and fines into the bale makes the bales denser, which makes the bales more water-resistant. Also, leaves and fines generally have lots of nutrients that are desirable to feed to animals and therefore which users would not wish to lose.

The attachment means 13 secures the present invention to the rear axle 31 of a round baler 32. The attachment means 13 is designed to hold the first panel 11 of the present invention in a flexible position relative to the rear axle 13 to account for the vertical movement of the round baler 32 when in use, thereby ensuring that the present invention will be in proper position to catch leaves and fines that would ordinarily fall through the gap between the pickup head 33 and the rear axle 31. The attachment means 13 is depicted in FIGS. 2 and 3 as a hinged bracket secured to the first panel 11 and to the rear axle 31 via screws, however no claim is made as to the precise attachment means 13. The attachment means 13 may be either removable or permanent.

In use an individual affixes the attachment means to the rear axle of a round baler and places the present invention across the gap between the round baler pickup head and the rear axle. Leaves and fines ordinarily fall through this gap that is present on many types of commercially available round balers and are not incorporated into the bales that are created. This is undesirable because leaves and fines make bales denser, and thus more water-resistant, and have nutrients. When in use, leaves and fines collect on the present round baler debris catcher and are incorporated into the bales as they pile up on the device. The connection means between the present invention and the rear axle of the round baler is flexible so that the present invention can adjust to the vertical movement of the round baler when in use, ensuring that the maximum amount of leaves and fines are caught.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A debris catching system adapted for use with round balers, comprising:
a member having a first panel and a second panel;
said first panel having a first end and a second end;
said second panel attached to said first end in an angled relationship relative to said first panel;
said member adapted to span a gap between a round baler pickup head and a round baler rear axle to catch leaves and fines that would ordinarily fall therethrough;
an attachment means attached to said second end.

2. The debris catching system of claim 1, wherein said first panel and said second panel are hingedly attached.
